(19) United States
(12) Patent Application Publication
(10) Pub. No.: US 2006/0221003 A1
(43) Pub. Date: Oct. 5, 2006

(54) Flat-panel video display apparatus and its drive method

(75) Inventors: Yasuhiro Ookawara, Ome-shi (JP); Yoshihiko Ogawa, Ome-shi (JP); Ken Ito, Ome-shi (JP); Hiroshi Yoshimura, Saitama-shi (JP); Ko Sato, Ome-shi (JP); Keiko Hirayama, Yokohama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/377,667

(22) Filed: Mar. 17, 2006

(30) Foreign Application Priority Data
Mar. 31, 2005 (JP) 2005-104428

(51) Int. Cl. G09G 3/22

(52) U.S. Cl. 345/75.2

(57) ABSTRACT

There is provided a flat-panel video display apparatus, which improves a brightness of a screen at low price and low power consumption, and reduces flicker. When a scanning line is successively driven by several lines, the apparatus is provided with means for supplying a first voltage to a driven main scanning line, and for supplying a second voltage lower than the first voltage or third voltage having a drive period shorter than a drive period of the main scanning line to simultaneously drive other sub-scanning lines.

### CROSS-REFERENCE TO RELATED APPLICATIONS

This application is based upon and claims the benefit of priority from Japanese Patent Application No. 2005-104428, filed Mar. 31, 2005, the entire contents of which are incorporated herein by reference.

### BACKGROUND

1. Field

One embodiment of the invention relates to flat-panel video display apparatus using a field emission type element and plasma light-emitting element, and to its drive method. Moreover, the present invention relates to a flat-panel video display apparatus, which can improve brightness without reducing vertical resolution.

2. Description of the Related Art

There has been known a flat-panel image display apparatus having many electron emission elements arranged facing a fluorescent surface as a next-generation image display apparatus. The electron emission element has various kinds, and in general, is called a field emission display (hereinafter, referred to as FED). Of the FEDs, a display apparatus using a surface conductance emitter is called a surface conductance electron emission display (hereinafter, referred to as SED).

The image display apparatus has front and backside substrates, which are arranged facing each other with a predetermined distance. These substrates form a vacuum vessel in a manner of mutually welding their peripheral edges via rectangular sidewalls. In order to support an atmospheric load applied to the backside and front substrates, several support members are interposed between these substrates.

The inner surface of a pixel area of the front substrate is formed with a fluorescent surface including red (R), Blue (B) and green (G) fluorescent material layers. On the other hand, the inner surface of the backside substrate is provided with a large number of electron emission elements, which emit electrons for exciting the fluorescent materials to emit light.

Moreover, many scanning lines and signal lines are formed like a matrix, and connected to each electron emission element. A voltage corresponding to a video signal is applied to the electron emission element.

An acceleration voltage is applied to the fluorescent surface. An electron beam emitted from the electron emission element is accelerated via the acceleration voltage, and then, collates with the fluorescent surface. By doing so, the fluorescent material emits light; therefore, a video image is displayed.

In the image display apparatus, the distance between the front and backside substrates is set to several millimeters (mm) or less. Therefore, the image display apparatus is lightened and thinned as compared with a cathode ray tube (CRT) used as a display for current televisions and computers.

Meanwhile, in the foregoing image display apparatus, the technique of preventing flicker from occurring due to interlace scanning and the technique of improving the brightness of a screen have been studied. The foregoing related techniques are disclosed in Japanese Patent Application Publications (KOKAI) No. 2004-219884, and No. 2004-264790.

According to the foregoing techniques of preventing flicker from occurring due to interlace scanning and improving the brightness of a screen, a 2-line simultaneous drive system is employed. Specifically, horizontally arranged electron emission elements are successively driven by two lines, and not by one line. The driving is performed in the manner described above, and thereby, flicker is reduced as compared with the conventional case of successively driving these elements by one line according to interlace scanning. Moreover, the brightness is improved.

However, the same image signal is supplied to two lines; for this reason, vertical resolution is reduced. In order to solve the reduction of the vertical resolution, a technique of using a vertical filter has been studied.

However, according to the foregoing technique, a circuit such as vertical filter must be newly added to an image processing circuit. In addition, power consumption is increased because the circuit is added and two lines are driven.

### SUMMARY

An object of the embodiments is to provide a flat-panel video display apparatus, which improves a brightness of a screen at low price and low power consumption, and reduces flicker, and further, prevents vertical resolution from being reduced, and to provide its drive method.

In order to achieve the foregoing object, according to one embodiment, if the scanning line is driven every several lines, a driven main scanning line is supplied with a first voltage. On the other hand, the other simultaneously driven sub-scanning line is supplied with a second voltage lower than the first voltage. The foregoing means is provided if only voltage selection of the vertical drive circuit and drive sequence are changed. Therefore, it is possible to realize a flat-panel video display apparatus, which reduces power consumption at low price.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of a flat-panel video display apparatus according to one embodiment of the invention;

FIG. 2 is an exemplary cross-sectional view to explain an example of the basic structure of a display unit (section) 17 of FIG. 1;

FIG. 3 is a graph to explain an example of the output characteristic of an electron emission source shown in FIG. 2;

FIG. 4A is an exemplary view to explain a method of driving the display apparatus shown in FIG. 1 and FIG. 2;

FIG. 4B is an exemplary view to explain a method of driving the display apparatus shown in FIG. 1 and FIG. 2;

FIG. 5A is an exemplary view showing a scanning line luminance state to explain the basic operation of the apparatus according to the present invention;

FIG. 5B is an exemplary view showing signal line voltage, scanning line and sub-scanning line drive signals to explain the basic operation of the apparatus according to the present invention;

FIG. 5C is an exemplary view showing another signal line voltage, scanning line and sub-scanning line drive signals to explain the basic operation of the apparatus according to the present invention;

FIG. 6 is an exemplary view showing a state that a drive voltage applied to scanning lines changes for every field to explain the basic operation of the apparatus according to the embodiment of the invention;

FIG. 7A is an exemplary view showing a state that scanning line luminance changes on a display screen when the apparatus is driven according to the scanning line signal shown in FIG. 6;

FIG. 7B is an exemplary view showing a state that scanning line luminance changes on a display screen when the apparatus is driven according to the scanning line signal shown in FIG. 6;

FIG. 8 is an exemplary view showing a scanning line luminance state in another embodiment of the invention; and

FIG. 9 is an exemplary block diagram showing each internal configuration of signal line drive unit 15 and scanning line drive unit 16a included in the apparatus according to one embodiment of the invention.

### DETAILED DESCRIPTION

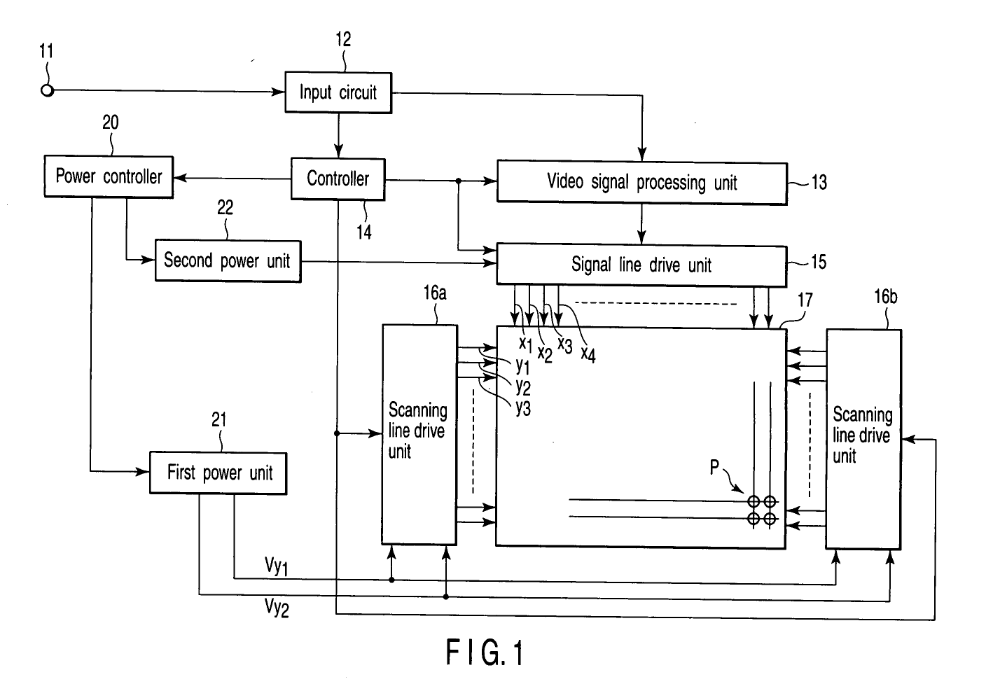

Various embodiments according to the invention will be described hereinafter with reference to the accompanying drawings. FIG. 1 shows an example of the configuration of a flat-panel video display apparatus to which the invention is applied.

A video signal is inputted to an input terminal 11, and then, supplied to a video signal processing unit (or section) 13 via an input circuit 12. The input circuit 12 extracts a synchronizing signal from the inputted video signal to generate clock synchronous with the video signal. Simultaneously, the input circuit 12 generates various timing signals, and thereafter, supplies them to a controller 14.

The video signal processing unit 13 makes signal processing such as correction with respect to the video signal inputted from the input circuit 12, and thereafter, outputs it to a signal line drive unit 15.

A one-scanning line signal from the signal line drive unit 15 is simultaneously supplied to the corresponding electron emission source group of a display unit 17. Scanning line drive units 16a and 16b select the electron emission source group. The scanning line drive units 16a and 16b are provided to drive allocated left and right sides of the scanning line of the display unit 17, respectively. In this case, only one of the scanning line drive units may be provided.

The foregoing signal line drive unit 15, scanning line drive units 16a and 16b need to apply a proper voltage to signal lines and scanning lines. The power system will be described below.

A timing signal from the controller 14 is supplied to a power controller 20. The power controller 20 controls first and second power units 21 and 22. The second power unit 22 determines a reference (basic) voltage of the signal supplied from the signal line drive unit 15 to the signal line. The first power unit 21 outputs two voltages, that is, voltage |Vy1| and voltage |Vy2|. Significance and effect given by obtaining the foregoing two voltages |Vy1| and |Vy2| will be described later. In FIG. 1, x1, x2, x3 . . . denote a signal line; and y1, y2, y3, . . . denote a scanning line. Several elements P forming a pixel are two-dimensionally arrayed in the vicinity of the intersection of the signal line and the scanning line.

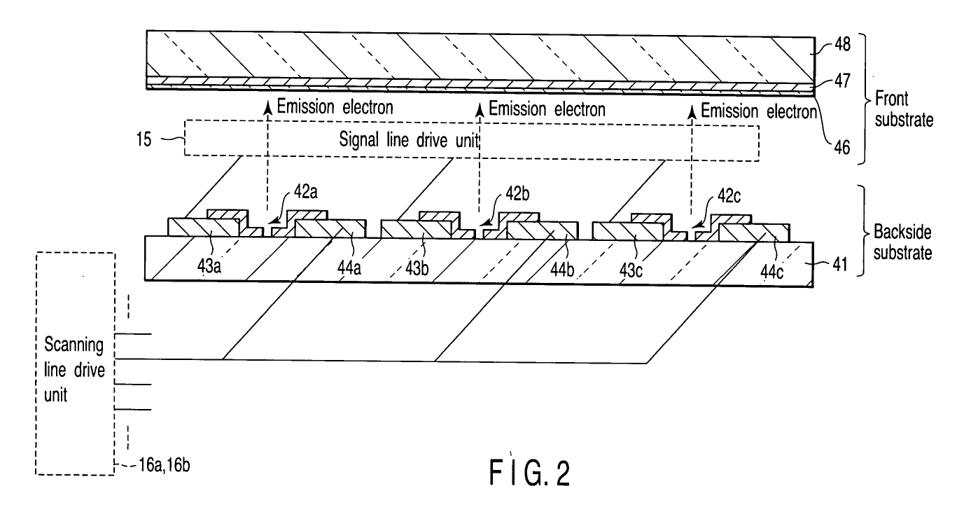

FIG. 2 is a view showing an example of the structure of the display unit 17, that is, the basic principle of an SED. A backside substrate is provided with electron emission sources 42a to 42c forming an element P, which are arrayed on a glass substrate 41. In FIG. 2, there are shown three electron emission sources; in this case, these electron emission sources are two-dimensionally arrayed on the glass substrate 41 to form a display area. In addition, one electron emission source is connected with one scanning line and one signal line. Several signal lines 43a to 43c are arranged in parallel on the glass substrate 41, and wired (interconnected) in a longitudinal direction. Moreover, several scanning lines 44a to 44c are arranged in parallel on the glass substrate 41, and wired (interconnected) in a traverse direction. One electrode of the electron emission source is connected to a scanning line from the scanning line drive unit 16a, 16b. The other electrode of the electron emission source is connected to a signal line from the signal line drive unit 15. Therefore, a potential difference between the potential from the scanning line and the potential from the signal line is generated between two electrodes of the electron emission source. An electron emitted between the two electrodes travels toward a metal back 46 of a front substrate. Then, the electron collates with a fluorescent material of a fluorescent material layer 47 formed on the backside of the metal back 46, and therefore, light emission (luminescence) occurs there. For example, the fluorescent material layer 47 includes an RGB fluorescent material layer and black matrix layer interposed therein. The fluorescent material layer 47 is formed at the inner side of a glass substrate 48. For example, electrons emitted from electron emission sources 42a to 42c collate with the RGB fluorescent material layer, and thereby, color display is obtained.

The foregoing signal line is connected to the signal line drive unit 15; on the other hand, the scanning line is connected to the scanning line drive unit 16a, 16b. A voltage applied to each of signal and scanning lines will be described below.

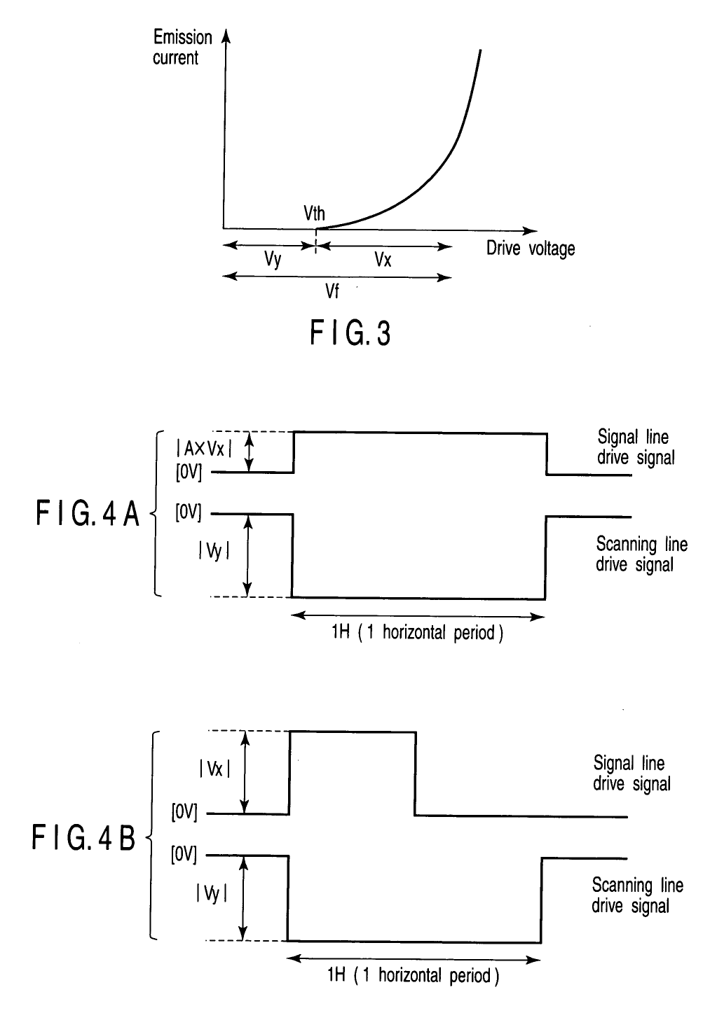

FIG. 3 shows the relationship between a voltage Vf applied between two electrodes of the electron emission source and an emission current. In FIG. 3, Vy denotes a potential (voltage) applied to the scanning line, and Vx denotes a potential (voltage) applied to the signal line. The following relation is given.

V=absolute value Vy+absolute value Vx

As seen from FIG. 3, the potential Vx of the signal line is varied, and thereby, an emission current is controlled. This implies that luminance is varied according to the potential of the signal outputted from the signal line drive unit 15.

FIG. 4A and FIG. 4B show different examples (methods) of varying the luminance on one scanning line. According to the example of FIG. 4A, a potential Vy is applied to the scanning line for one horizontal period; on the other hand, a potential A×Vx is applied to the signal line for one horizontal period. According to the example of FIG. 4B, a potential Vy is applied to the scanning line for one horizontal period; on the other hand, a potential Vx (e.g.,=Vy) is applied to the signal line for ½ horizontal period. In other words, the case shown in FIG. 4A shows a method of varying amplitude of signal to change the luminance. On the other hand, the case shown in FIG. 4B shows a method of varying a pulse width of signal to change the luminance. The foregoing methods may be combined to change the luminance.

According to the embodiment, a horizontal line (scanning line) is driven by several lines. In this case, a driven main scanning line is supplied with the first voltage Vy. On the other hand, the simultaneously driven other sub-scanning line is supplied with a second voltage lower than the first voltage |Vy|. Or, there is provided a means for supplying a third voltage having a drive period shorter than the drive period of the main scanning line.

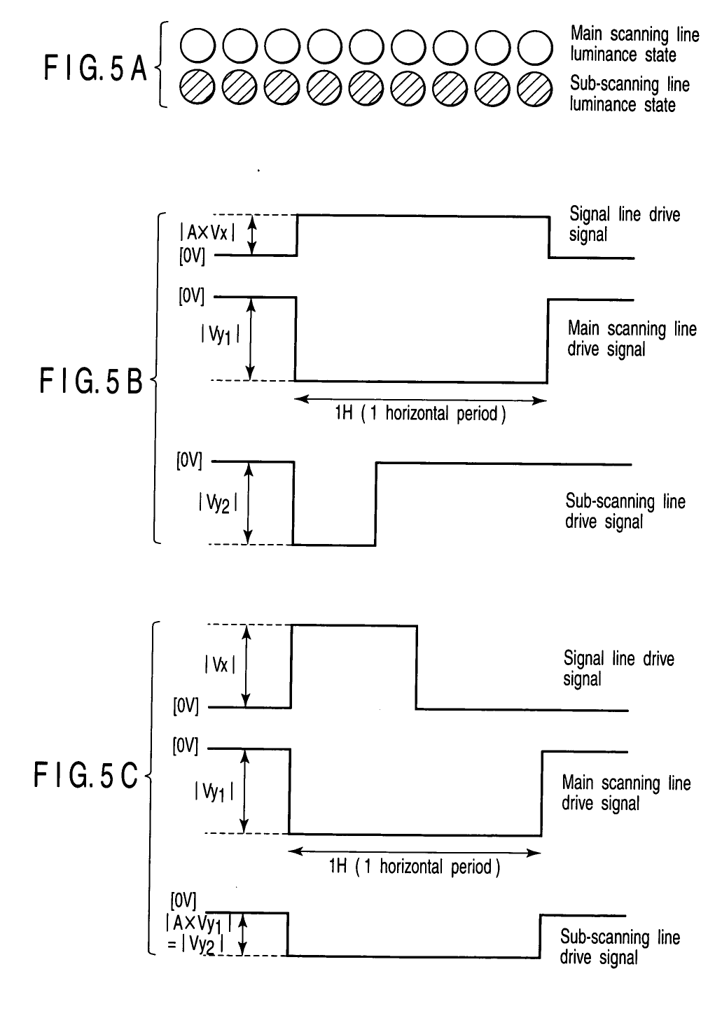

FIG. 5A shows main scanning and sub-scanning line luminance states when several lines are simultaneously driven as described above. In order to obtain the luminance state, voltage supply methods shown in FIG. 5B and 5C are employed. According to the voltage supply method shown in FIG. 5B, in a voltage |Vy2| supplied to the sub-scanning line, the supply period is shorter than a voltage |Vy1| supplied to the main scanning line although the voltage value is the same as the voltage |Vy1|. According to the voltage supply method shown in FIG. 5C, in a voltage |Vy2| supplied to the sub-scanning line, the amplitude is smaller than the voltage IVyll supplied to the main scanning line although the supply period is the same as the voltage |Vy1|.

The foregoing voltages |vy1| and |Vy2| are obtained from the first power unit 21 shown in FIG. 1. The luminance of the sub-scanning line is small according to the voltage |Vy2|; therefore, vertical resolution is not largely reduced even if two-line scanning is carried out. Conversely, the following effects are obtained; specifically, the screen brightness is improved, and flicker is reduced.

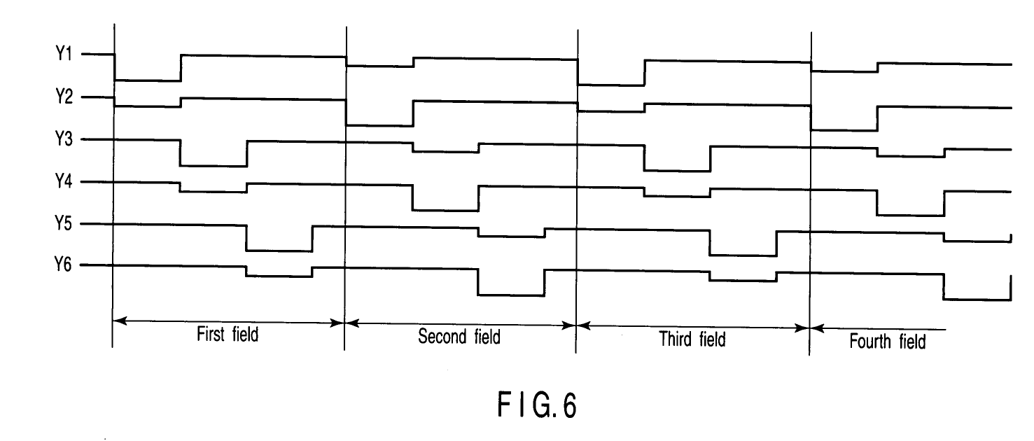

FIG. 6 shows each state from first to fourth fields of voltages applied to six scanning lines. FIG. 6 shows the case where when two scanning lines are simultaneously driven, the voltage |Vy2| supplied to the sub-scanning line has an amplitude smaller than the voltage |Vy1| supplied to the main scanning line although the supply period is the same as the voltage |Vy1|.

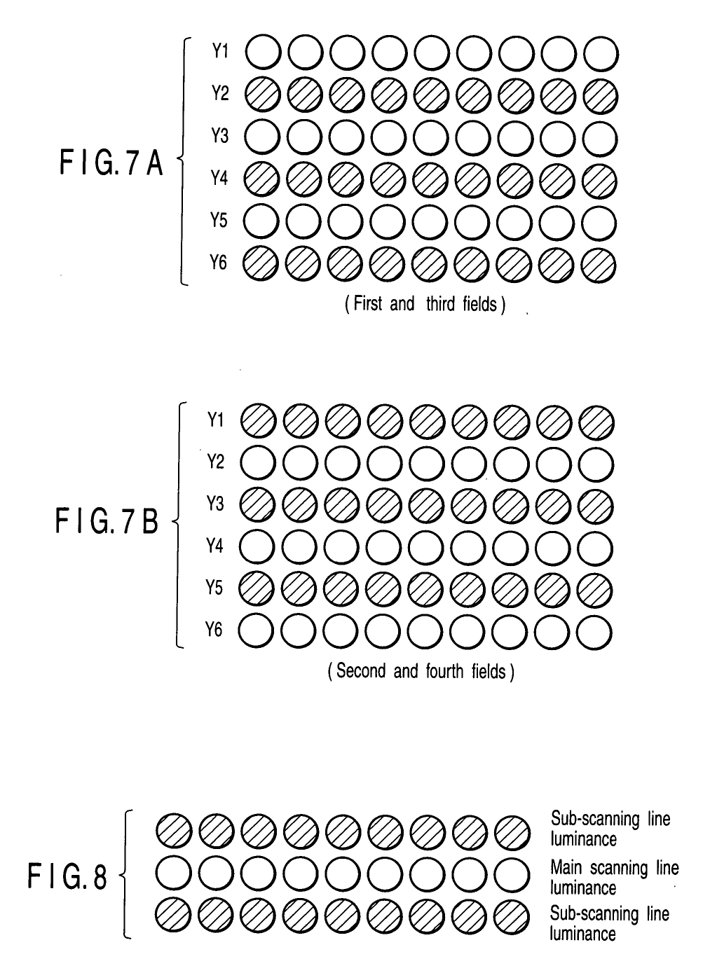

FIG. 7A and FIG. 7B show an example of main scanning line luminance state and sub-scanning line luminance state when a voltage is supplied as described in FIG. 6, respectively. In this case, the signal line voltage is constant.

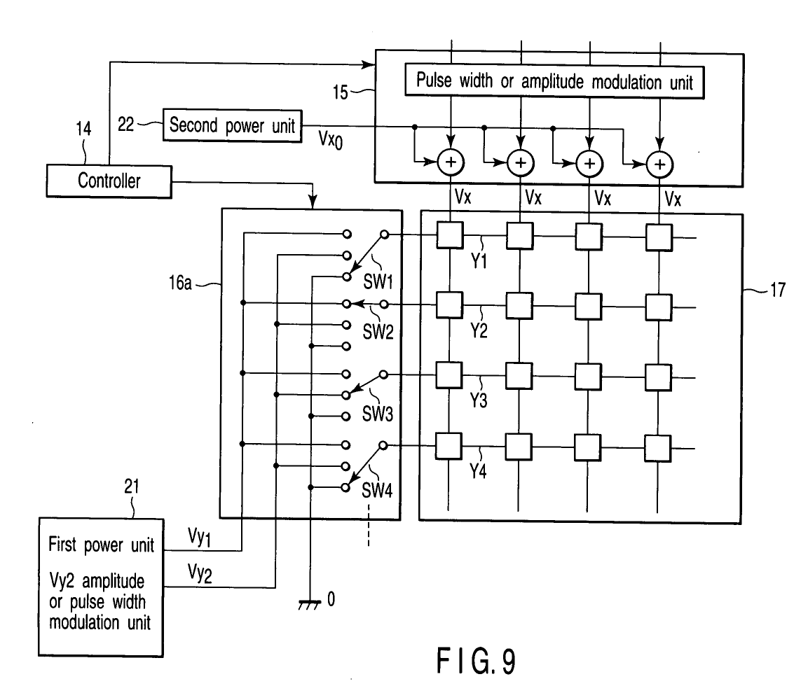

FIG. 8 shows another example when three scanning lines are simultaneously driven. Scanning lines positioned above and below the main scanning line are given as a sub-scanning line.

FIG. 9 shows an example of the internal configuration of the signal line drive unit 15 and the scanning line drive unit 16a. The scanning line drive unit 16a includes select circuits SW1 to Sw4 for applying any of a voltage |Vy1| for main scanning line, voltage |Vy2| for sub-scanning line and voltage (OV) for non-drive scanning line to each scanning line. FIG. 9 shows a state when a scanning line Y2 is used as a main scanning line, and a scanning line Y3 is driven as a sub-scanning line. A voltage having an amplitude or pulse width corresponding to a signal level is applied to the signal line. The first power unit 21 includes a Vy2 amplitude or pulse width modulation unit. The amplitude value or pulse width is determined according to setting parameters from the controller 14.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video display apparatus comprising:
a plurality of signal lines;
a plurality of scanning lines intersecting with said plurality of signal lines;
two-dimensionally arrayed elements to be selected by the corresponding scanning line, and to be supplied with a signal from the corresponding signal line;
a scanning line drive unit setting a main scanning line and a sub-scanning line adjacent to each other in said plurality of scanning lines to simultaneously drive them, and successively scanning them, and further, supplying a first voltage to the main scanning line, supplying a second or third voltage to the sub-scanning line, supplying a reference voltage to a non-drive scanning line, the second voltage being lower than the first voltage, the third voltage being shorter than a drive period of the main scanning line and having a drive period; and
a signal line drive unit supplying a signal to an element connected to a scanning line driven by the scanning line drive unit via said plurality of signal lines.

2. The apparatus according to claim 1, wherein said plurality of elements comprise electron emission elements.

3. The apparatus according to claim 1, wherein the scanning line drive unit includes a select circuit for selecting the first voltage, the second voltage or third voltage, and the reference voltage.

4. The apparatus according to claim 1, wherein the scanning line drive unit includes a select circuit for selecting the first voltage, the second voltage or third voltage, and the reference voltage.

5. The apparatus according to claim 1, wherein the scanning line drive unit includes an amplitude modulation circuit for generating the second voltage.

6. The apparatus according to claim 1, wherein the scanning line drive unit includes a pulse width modulation circuit for generating the third voltage.

7. A video display apparatus comprising:
a plurality of signal lines;
a plurality of scanning lines intersecting with said plurality of signal lines;
two-dimensionally arrayed elements to be selected by the corresponding scanning line, and to be supplied with a signal from the corresponding signal line;
a scanning line drive unit selectively driving said plurality of scanning lines;
a signal line drive unit supplying a signal to an element connected to a scanning line driven by the scanning line drive unit via said plurality of signal lines; and
a power unit for supplying a voltage to the scanning line via the scanning line drive unit,
the scanning line drive unit setting a main scanning line and a sub-scanning line adjacent to each other in said plurality of scanning lines to simultaneously drive them, and successively scanning them, and further, including means for supplying a first voltage to the main scanning line, for supplying a second lower than the first voltage or third voltage having a drive period shorter than a drive period of the main scanning line to the sub-scanning line, and for supplying a reference voltage to a non-drive scanning line,
the power unit including a circuit for generating the first voltage and the second or third voltage.

8. The apparatus according to claim 7, wherein said plurality of elements are electron emission elements.

9. The apparatus according to claim 7, wherein a circuit generating the second voltage is an amplitude modulation circuit.

10. The apparatus according to claim 7, wherein a circuit generating the third voltage is a pulse width modulation circuit.

11. A drive method of a video display apparatus including: a plurality of signal lines; a plurality of scanning lines intersecting with said plurality of signal lines; two-dimensionally arrayed elements to be selected by the corresponding scanning line, and to be supplied with a signal from the corresponding signal line; a scanning line drive unit selectively driving said plurality of scanning lines; a signal line drive unit supplying a signal to an element connected to a scanning line driven by the scanning line drive unit via said plurality of signal lines; a power unit for supplying a voltage to the scanning line via the scanning line drive unit; and a controller, comprising:
controlling the scanning line drive unit so that the scanning line drive unit sets a main scanning line and a sub-scanning line adjacent to each other in said plurality of scanning lines to simultaneously drive them, and successively scans them, and further, supplies a first voltage to the main scanning line, supplies a second lower than the first voltage or third voltage having a drive period shorter than a drive period of the main scanning line to the sub-scanning line, and supplies a reference voltage to a non-drive scanning line, in the controller; and
controlling the power unit so that the power unit generates the first voltage or second or third voltage.
